(19) United States
(12) Patent Application Publication
(10) Pub. No.: US 2004/0254277 A1
(43) Pub. Date: Dec. 16, 2004

(54) Fishing lure

(76) Inventors: Michael T. Shelton, North Charleston, SC (US); Donald W. Rawlins, Brooklet, GA (US)

Correspondence Address: ROBERT H. HAMMER III, P.C., 3121 SPRINGBANK LANE, SUITE I, CHARLOTTE, NC, 28226, US

(21) Appl. No.: 10/460,063

(22) Filed: Jun. 12, 2003

(51) Int. Cl. C08J 3/00

(52) U.S. Cl. 524/313

(57) ABSTRACT

A fishing lure or bait is a shaped body of a gelatinous elastomeric composition. The gelatinous elastomeric composition is made from a styrenic block copolymer and an oil mixture of a first oil and a second oil.

### FIELD OF THE INVENTION

A fishing lure or bait is made of a synthetic rubber composition.

### BACKGROUND OF THE INVENTION

Many commercially available fishing lures and baits are made from plastisol. Plastisol is a dispersion or emulsion of polyvinyl chloride (PVC) resin in a plasticizer. Lures and baits made of various plastisols have been widely accepted. They can be molded into various shapes, are easily colored, and are relatively inexpensive. Additionally, they appear lifelike. The plastisol fishing bait, however, is deficient in that it is not very elastic, it is susceptible to tearing, it is relatively hard (salt water lure—Shore 00 hardness 35-40; fresh water lure—Shore 00 hardness 20+), it is perceived as environmentally unsafe, and while it appears lifelike, it does not feel lifelike.

Recently, it has been proposed that these fishing lures be made of a synthetic rubber as opposed to plastisols. Price, S., “New soft plastic have fishing world excited,” BASSMASTER, July 2002. Stout, L., “Revolutionary Plastics, New technology may radically alter soft plastic lure market,” B.A.S.S. Times, and U.S. Pat. Nos. 5,884,639, 6,117,176, and 6,148,830. Specifically, these synthetic rubbers are thermoplastic elastomers (TPE); and more specifically, they are styrenic block copolymer. These new lures are a significant improvement over the plastisol lures. The new lures can be colored, shaped, are softer, and are elastic. These new lures not only look lifelike, but they also feel lifelike.

The first lures made with these synthetic rubbers, however, were not problem-free. One concern is the surface tackiness of the lure. The synthetic rubber has a high surface tack; therefore, it tends to cling to anything it comes into contact with. One solution to the surface tack concern is set forth in copending U.S. patent application Ser. No. 10/378,489 filed Mar. 3, 2003 by M. T. Shelton. Another concern is heat deformation. Heat deformation refers to the body losing its original shape after being exposed to an elevated temperature for a prolonged period of time (e.g. 50° C. for 1 hour). For example, a worm-shaped lure (i.e., generally rod-like) may be bent or folded in storage, and during storage, it may see temperatures greater than 100° F. (38° C.), and after cooling, the bent or folded worm may not return to its original shape. Heat deformation is undesirable from a consumer point-of-view. Still another problem is processibility. Processibility refers to the flowability of the extrudate into the cavities of the mold while retaining reasonable cycle times. The extrudate must have the proper flow characteristics to completely fill all cavities of the mold; such molds may have from 12 to 150 cavities per mold. Still other considerations include maintaining elasticity and tear resistance. Each of these properties must be balanced to achieve a good quality lure. These properties, it is believed, are dependent, in part, on the choice of the components of the synthetic rubber composition and their relative quantities in the mixture.

One prior art composition of blended styrenic block copolymers (SEEPS (styrene ethylene/ethylene-propylene-styrene), SEBS (styrene ethylene/butylene styrene), and SEPS (styrene ethylene/propylene styrene)) and a single oil (SEMTOL) produced lures with unacceptable heat deformation.

Accordingly, there is a need for a new fishing lure made of a synthetic rubber composition that has, among other things, low heat deformation and good processibility.

### SUMMARY OF THE INVENTION

A fishing lure or bait is a shaped body of a gelatinous elastomeric composition. The gelatinous elastomeric composition is made from a styrenic block copolymer and an oil mixture of a first oil and a second oil.

### DESCRIPTION OF THE INVENTION

Lures and baits may come in many various shapes. Lure and bait are used interchangeably herein. For example, the shape may be that of a lizard or a worm. Other shapes include: salamanders, fan tails, curly tail jigs, quad tail jigs, curly tail worms, split-tails, worm-crawfish, minnows, double tails, ripple tail worms, and the like. Further, the shape may also include a ‘rattle pocket’ for a rattle. For example, see U.S. Pat. No. 4,993,183 and U.S. Patent Application Publication No. 2002/0188057A1, both incorporated herein by reference.

The gelatinous elastomeric composition is a mixture of a thermoplastic elastomer (TPE) and an oil (or plasticizer). Preferably, this composition is a mixture of a styrenic block copolymer and an oil, where the oil is in excess, by weight, of the copolymer. Most preferably, the composition is a mixture of one or more styrenic block copolymers and at least two oils.

These gelatinous elastomeric compositions are elastic, tear resistant, and soft. They are elastic and can be stretched several times their original length. They are tear resistant and can withstand tearing. They are soft and have a Shore 00 hardness less than 10, preferably 4-6.

The styrenic block copolymers are thermoplastic elastomers. Their structure normally consists of a block of a rigid styrene on each end with a rubbery phase in the center. Styrenic block copolymers include, but are not limited to, SBS (styrene butadiene styrene), SIS (styrene-isoprene-styrene), SEPS (styrene ethylene/propylene styrene), SEBS (styrene ethylene/butylene styrene), and SEEPS (styrene ethylene/ethylene-propylene-styrene). These materials are commercially available from, for example, SEPTON Company of America, Pasadena, Tex. and KRATON Polymers, Houston, Tex. Exemplary SEPTON (US) products include SEPTON 4055 (SEEPS); SEPTON 8006 (SEBS); and SEPTON 2006 (SEPS). Exemplary KRATON (US) products include KRATON 1651 (SEBS). Additional properties are set out in TABLE 1 below.

TABLE 1

| | 8006 | 4055 | 2006 | 1651 |
|---|---|---|---|---|
| Styrene Content (wt %) | 33 | 30 | 35 | 33 |
| Spec Gravity (ASTM D-792) | 0.92 | 0.92 | 0.92 | 0.91 |
| Hardness (Shore A) ASTM | 79 | 78 | | 61 |
| D-2240 | | | | |
| Melt Index (ASTM D-1238) | | | | |
| @ 230° C., 2.16 kg (g/10 mm) | No flow | No flow | No flow | <1 (5 kg) |
| @ 200° C., 10 kg (g/10 mm) | No flow | | No flow | |
| Brookfield Viscosity | | | | |
| (Toluene Soln, 30° C.) | | | | |
| 5 wt % | 41 | 90 | 27 | |
| 10 wt % | | 5800 | 120 | 1800 |
| 25 wt % | | | | >50,000 |

The oil or plasticizer generally refers to mineral oils or silicone (dimethyl silaxone) oil. The oil is mixed with the styrenic block copolymer. It was learned during experimental work leading to this invention that increasing the amount of the heavier oils (i.e., greater molecular weights or greater viscosity) decreased heat deformation and processibility, and increased surface tack. Such oils are commercially available from, for example, Crompton Corporation (Witco Refined Products), Greenwich, Conn. Exemplary oils include: BLANDOL white mineral oil, CARNATION white mineral oil, KLEAROL white mineral oil, SEMTOL white mineral oil, and WITCO 40 OIL white mineral oil. Additional properties are set out in TABLE 2 below.

TABLE 2

| | BLANDOL | CARNATION | KLEAROL | SEMTOL 40 | WITCO 40 |
|---|---|---|---|---|---|
| Specific Gravity | 0.839/0.855 | 0.829/0.845 | 0.827/0.838 | 0.804/0.827 | 0.810/0.830 |
| @ 25%/25° C. | | | | | |
| (ASTM D4052) | | | | | |
| Kinematic Viscosity | 14.2/17.0 | 10.8/13.6 | 6.7/9.7 | 3.9/5.5 | 3.9/5.0 |
| @ 40° C., CST | | | | | |
| (ASTM D445) | | | | | |
| Color, Saybolt | +30 min | +30 min | +30 min | +30 min | +30 min |
| (ASTM D156) | | | | | |
| Pour Point, | −7 | −7 | −2 | −2 | 2 max |
| ° C. (ASTM D97) | | | | | |
| Cloud Point, | | | | | 4 max |
| ° C. (ASTM D2500) | | | | | |

A heat distortion additive maybe added to reduce or minimize the effects of the heat deformation mentioned above. Heat distortion additives include, but are not limited to, ENDEX 160, ENDEX 155, and GE PPO BLENDEX HPP821.

Other conventional additives may also be added. Such additives include: UV-stabilizer, heat-stabilizer, pigments, dyes, flavorant, attractants, and the like.

In the gelatinous elastomeric composition, the oil is in excess, by weight, of the styrenic block copolymer. The copolymer may comprise 5-20% by weight of the composition, while the oil may comprise 80-95% by weight of the composition. Preferably, the copolymer comprises about 12-13% of the composition, while the oil comprises about 87-88% of the composition.

The copolymer component of the composition may comprise a single copolymer or a mixture of copolymers. If a single copolymer is used, SEBS is preferred. If a mixture of copolymers is used, SEEPS and SEBS or SEPS/SEBS combinations are preferred. Lures made with SEBS alone are adequate from a elastic and tear resistance perspective, but mixtures can provide superior elastic and tear resistant properties. In the mixtures, it is preferred that the SEEPS component be the major component. Exemplary copolymer component formulations include 4-13% SEEPS, 1-5% SEBS, 0-2% SEPS. Most preferred is 9% SEEPS, 3% SEBS, and 1% SEPS.

The invention will be further illustrated in the following examples.

### EXAMPLES

The following gels were made with 600 parts by weight of oil, 0.5 parts by weight of an antioxidant (IRGANOX 1010), and 0.5 parts by weight of a UV stabilizer (TINUVIN P), melt blended in a 16×150 mm glass test tube, cooled, removed, and 180° U blend tested 50° C. for 1.0 hour:

1. 80 parts by weight of SEPTON 4055 and 20 parts by weight of SEPTON 2006, block copolymers, WITCO 40 OIL, the gel sample retained a deformation of about 30° C.

2. 80 parts by weight of SEPTON 8006 and 20 parts by weight of SEPTON 4055, block copolymers, 35 parts by weight of a heat distortion additive (ENDEX 160), WITCO 40 OIL, the gel heat tested sample retained a deformation of about 84°.

3. Gels of 90 parts by weight of SEPTON 8006 and 10 parts by weight of SEPTON 4055, block copolymers, 35 parts by weight of a heat distortion additive (ENDEX 160), WITCO 40 OIL, the gel heat tested sample retained a deformation of about 85°.

4. Gels of 80 parts by weight of SEPTON 8006 and 20 parts by weight of SEPTON 4055, block copolymers, 45 parts by weight of a heat distortion additive (ENDEX 160), WITCO 40 OIL, the gel heat tested sample retained a deformation of about 91°.

5. Gels of 90 parts by weight of SEPTON 8006 and 10 parts by weight of SEPTON 4055, block copolymers, 45 parts by weight of a heat distortion additive (ENDEX 160), WITCO 40 OIL, the gel heat tested sample retained a deformation of about 95°.

6. Gels of 100 parts by weight of SEPTON 8006, block copolymers, 25 parts by weight of ENDEX 155, WITCO 40 OIL, the gel heat tested sample retained a deformation of about 56°.

7. Gels of 100 parts by weight of SEPTON 8006, block copolymers, 45 parts by weight of a heat distortion additive (ENDEX 155), WITCO 40 OIL, 0.5 parts by weight of IRGANOX 1010, the gel heat tested sample retained a deformation of about 57°.

8. Gels of 100 parts by weight of SEPTON 4055, block copolymers, WITCO 40 OIL, the gel heat tested sample retained a deformation of about 90°.

9. Gels of 60 parts by weight of SEPTON 4055 and 30 parts by weight of KRATON 1651 block copolymers, WITCO 40 OIL, the gel heat tested sample retained a deformation of about 45°.

10. Gels of 30 parts by weight of SEPTON 4055 and 60 parts by weight of KRATON 1651 block copolymers, WITCO 40 OIL, the gel heat tested sample retained a deformation of about 55°.

11. Gels of 100 parts by weight of SEPTON 8006 block copolymers in combination with 33 parts by weight of a heat distortion additive (GE PPO BLENDEX® HPP821), 600 parts by weight of WITCO 40 OIL, the gel heat tested sample retained a deformation of about 10°.

12. Gels of 60 parts by weight of SEPTON 4055 and 30 part by weight of KRATON 1651 block copolymers in combination with 33 parts by weight of a heat distortion additive (GE PPO BLENDEX® HPP821), WITCO 40 OIL, the gel heat tested sample retained a deformation of about 33°.

13. Gels of 100 parts by weight of SEPTON 4055 block copolymers in combination with 25 parts by weight of a heat distortion additive (GE PPO BLENDEX® HPP821), WITCO 40 OIL, the gel heat tested sample retained a deformation of about 30°.

14. Gels of 100 parts by weight of SEPTON 2006 block copolymers in combination with 25 parts by weight of a heat distortion additive (GE PPO BLENDEX® HPP821), WITCO 40 OIL, the gel heat tested sample retained a deformation of about 15°.

15. Gels of 100 parts by weight of SEPTON 8006 block copolymers in combination with 25 parts by weight of a heat distortion additive (GE PPO BLENDEX® HPP821), WITCO 40 OIL, the gel heat tested sample retained a deformation of about 35.

16. Gels of 100 parts by weight of KRATON 1651 block copolymers in combination with 25 parts by weight of a heat distortion additive (GE PPO BLENDEX® HPP821), WITCO 40 OIL, the gel heat tested sample retained a deformation of about 25°.

17. Gels of 100 parts by weight of SEPTON 4055 block copolymers in combination with 25 parts by weight of a heat distortion additive (ENDEX 155), WITCO 40 OIL, the gel heat tested sample retained a deformation of about 75°.

18. Gels of 100 parts by weight of SEPTON 2006 block copolymers in combination with 25 parts by weight of a heat distortion additive (ENDEX 155), WITCO 40 OIL, the gel heat tested sample retained a deformation of about 55°.

19. Gels of 100 parts by weight of SEPTON 8006 block copolymers in combination with 25 parts by weight of a heat distortion additive (ENDEX 155), WITCO 40 OIL, the gel heat tested sample retained a deformation of about 30°.

20. Gels of 100 parts by weight of KRATON 1651 block copolymers in combination with 25 parts by weight of a heat distortion additive (ENDEX 155), WITCO 40 OIL, the gel heat tested sample retained a deformation of about 27°.

21. Gels of 100 parts by weight of SEPTON 4055 block copolymers, BLANDOL, the gel heat tested sample retained a deformation of about 30°.

22. Gels of 100 parts by weight of SEPTON 4055 block copolymers, CARNATION, the gel heat tested sample retained a deformation of about 30°.

23. Gels of 100 parts by weight of SEPTON 4055 block copolymers, KLEAROL, the gel heat tested sample retained a deformation of about 40°.

25. Gels of 50 parts by weight of SEPTON 4055 and 50 parts by weight of SEPTON 2006 block copolymers (equal weight of BLANDOL and WITCO 40 OIL), the gel heat tested sample retained a deformation of about 57°.

26. Gels of 50 parts by weight of SEPTON 4055 and 50 parts by weight of SEPTON 2006 block copolymers, WITCO 40 OIL, the gel heat tested sample retained a deformation of about 78°.

27. Gels of 50 parts by weight of SEPTON 4055 and 50 parts by weight of SEPTON 2006 block copolymers, WITCO 40 OIL, the gel heat tested sample retained a deformation of about 80°.

28. Gels of 50 parts by weight of SEPTON 4055 and 50 parts by weight of KRATON 1651 block copolymers (equal weight of BLANDOL and WITCO 40 OIL), the gel heat tested sample retained a deformation of about 55°.

29. Gels of 100 parts by weight of SEPTON 2006 block copolymers (equal weight of BLANDOL and WITCO 40 OIL), the gel heat tested sample retained a deformation of about 45°. The resulting gel is highly tacky.

30. A Berkly and V & M PVC fishing baits were 180° U bend tested at 50° C. for 1.0 hour, both baits retained a deformation of about 34°.

The present invention may be embodied in other forms without departing from the spirit and the essential attributes thereof, and, accordingly, reference should be made to the appended claims, rather than to the foregoing specification, as indicated the scope of the invention.

1. A gel comprising 600 parts by weight of oil, 0.5 parts by weight of an antioxidant, 0.5 parts by weight of a UV stabilizer, 80 parts by weight of SEPTON 4055, 20 parts by weight of SEPTON 2006, and said oil being WITCO 40 OIL.

2. A gel comprising 600 parts by weight of oil, 0.5 parts by weight of an antioxidant, 0.5 parts by weight of a UV stabilizer, 80 parts by weight of SEPTON 8006, 20 parts by weight of SEPTON 4055, 35 parts by weight of a heat distortion additive, and said oil being WITCO 40 OIL.

3. A gel comprising 600 parts by weight of oil, 0.5 parts by weight of an antioxidant, 0.5 parts by weight of a UV stabilizer, 90 parts by weight of SEPTON 2006, 10 parts by weight of SEPTON 4055, 35 parts by weight of a heat distortion additive, and said oil being WITCO 40 OIL.

4. A gel comprising 600 parts by weight of oil, 0.5 parts by weight of an antioxidant, 0.5 parts by weight of a UV stabilizer, 80 parts by weight of SEPTON 8006, 20 parts by weight of SEPTON 4055, 45 parts by weight of a heat distortion additive, and said oil being WITCO 40 OIL.

5. A gel comprising 600 parts by weight of oil, 0.5 parts by weight of an antioxidant, 0.5 parts by weight of a UV stabilizer, 90 parts by weight of SEPTON 8006, 10 parts by weight of SEPTON 4055, 45 parts by weight of a heat distortion additive, and said oil being WITCO 40 OIL.

6. A gel comprising 600 parts by weight of oil, 0.5 parts by weight of an antioxidant, 0.5 parts by weight of a UV stabilizer, 100 parts by weight of SEPTON 8006, 25 parts by weight of a heat distortion additive, and said oil being WITCO 40 OIL.

7. A gel comprising 600 parts by weight of oil, 0.5 parts by weight of an antioxidant, 0.5 parts by weight of a UV stabilizer, 100 parts by weight of SEPTON 8006, 45 parts by weight of a heat distortion additive, and said oil being WITCO 40 OIL.

8. A gel comprising 600 parts by weight of oil, 0.5 parts by weight of an antioxidant, 0.5 parts by weight of a UV stabilizer, 100 parts by weight of SEPTON 4055, and said oil being WITCO 40 OIL.

9. A gel comprising 600 parts by weight of oil, 0.5 parts by weight of an antioxidant, 0.5 parts by weight of a UV stabilizer, 60 parts by weight of SEPTON 4055, 30 parts by weight of KRATON 1651, and said oil being WITCO 40 OIL.

10. A gel comprising 600 parts by weight of oil, 0.5 parts by weight of an antioxidant, 0.5 parts by weight of a UV stabilizer, 30 parts by weight of SEPTON 4055, 60 parts by weight of KRATON 1651, and said oil being WITCO 40 OIL.

11. A gel comprising 600 parts by weight of oil, 0.5 parts by weight of an antioxidant, 0.5 parts by weight of a UV stabilizer, 100 parts by weight of SEPTON 8006, 33 parts by weight of a heat distortion additive, and said oil being WITCO 40 OIL.

12. A gel comprising 600 parts by weight of oil, 0.5 parts by weight of an antioxidant, 0.5 parts by weight of a UV stabilizer, 60 parts by weight of SEPTON 4055, 30 parts by weight of KRATON 1651, 33 parts by weight of a heat distortion additive, and said oil being WITCO 40 OIL.

13. A gel comprising 600 parts by weight of oil, 0.5 parts by weight of an antioxidant, 0.5 parts by weight of a UV stabilizer, 100 parts by weight of SEPTON 4055, 25 parts by weight of a heat distortion additive, and said oil being WITCO 40 OIL.

14. A gel comprising 600 parts by weight of oil, 0.5 parts by weight of an antioxidant, 0.5 parts by weight of a UV stabilizer, 100 parts by weight of SEPTON 2006, 25 parts by weight of a heat distortion additive, and said oil being WITCO 40 OIL.

15. A gel comprising 600 parts by weight of oil, 0.5 parts by weight of an antioxidant, 0.5 parts by weight of a UV stabilizer, 100 parts by weight of SEPTON 8006, 25 parts by weight of a heat distortion additive, and said oil being WITCO 40 OIL.

16. A gel comprising 600 parts by weight of oil, 0.5 parts by weight of an antioxidant, 0.5 parts by weight of a UV stabilizer, 100 parts by weight of KRATON 1651, 25 parts by weight of a heat distortion additive, and said oil being WITCO 40 OIL.

17. A gel comprising 600 parts by weight of oil, 0.5 parts by weight of an antioxidant, 0.5 parts by weight of a UV stabilizer, 100 parts by weight of SEPTON 4055, 25 parts by weight of a heat distortion additive, and said oil being WITCO 40 OIL.

18. A gel comprising 600 parts by weight of oil, 0.5 parts by weight of an antioxidant, 0.5 parts by weight of a UV stabilizer, 100 parts by weight of SEPTON 2006, 25 parts by weight of a heat distortion additive, and said oil being WITCO 40 OIL.

19. A gel comprising 600 parts by weight of oil, 0.5 parts by weight of an antioxidant, 0.5 parts by weight of a UV stabilizer, 100 parts by weight of SEPTON 8006, 25 parts by weight of a heat distortion additive, and said oil being WITCO 40 OIL.

20. A gel comprising 600 parts by weight of oil, 0.5 parts by weight of an antioxidant, 0.5 parts by weight of a UV stabilizer, 100 parts by weight of KRATON 1651, 25 parts by weight of a heat distortion additive, and said oil being WITCO 40 OIL.

21. A gel comprising 600 parts by weight of oil, 0.5 parts by weight of an antioxidant, 0.5 parts by weight of a UV stabilizer, 100 parts by weight of SEPTON 4055, and said oil being BLANDOL.

22. A gel comprising 600 parts by weight of oil, 0.5 parts by weight of an antioxidant, 0.5 parts by weight of a UV stabilizer, 100 parts by weight of SEPTON 4055, and said oil being CARNATION.

23. A gel comprising 600 parts by weight of oil, 0.5 parts by weight of an antioxidant, 0.5 parts by weight of a UV stabilizer, 100 parts by weight of SEPTON 4055, and said oil being KLEAROL.

24. A gel comprising 600 parts by weight of oil, 0.5 parts by weight of an antioxidant, 0.5 parts by weight of a UV stabilizer, 50 parts by weight of SEPTON 4055, 50 parts by weight of SEPTON 2006, and said oil being equal weights of BLANDOL and WITCO 40 OIL.

25. A gel comprising 600 parts by weight of oil, 0.5 parts by weight of an antioxidant, 0.5 parts by weight of a UV stabilizer, 50 parts by weight of SEPTON 4055, 50 parts by weight of SEPTON 2006, and said oil being WITCO 40 OIL.

26. A gel comprising 600 parts by weight of oil, 0.5 parts by weight of an antioxidant, 0.5 parts by weight of a UV stabilizer, 50 parts by weight of SEPTON 4055, 50 parts by weight of KRATON 1561, and said oil being equal weights of BLANDOL and WITCO 40 OIL.

27. A gel comprising 600 parts by weight of oil, 0.5 parts by weight of an antioxidant, 0.5 parts by weight of a UV stabilizer, 100 parts by weight of SEPTON 2006, and said oil being equal weights of BLANDOL and WITCO 40 OIL.
